(19) United States
(12) Patent Application Publication
(10) Pub. No.: US 2026/0291155 A1
(43) Pub. Date: Sep. 24, 2026

(54) CONTROL ASSEMBLIES FOR CORDLESS LIQUID HEATING APPARATUSES

(71) Applicant: Strix Limited, Ronaldsway, Isle of Man (GB)

(72) Inventors: Marc Collinson, Crosby (GB); Raymond Doyle, Douglas (GB); Andrew Winstanley, Port Erin (GB)

(21) Appl. No.: 19/475,317

(22) PCT Filed: Apr. 12, 2024
(86) PCT No.: PCT/GB2024/050963

§ 371 Date: Oct. 14, 2025

(30) Foreign Application Priority Data
Apr. 13, 2023 (GB) 2305464.6
May 12, 2023 (CN) 202310540178.4

(51) Int. Cl. H01R 24/68; A47J 27/21; H01R 24/38; H01R 24/58; H01R 107/00

(52) U.S. Cl. CPC H01R 24/68; A47J 27/2105; H01R 24/38; H01R 24/58; H01R 2107/00

(57) ABSTRACT

A control assembly, for a cordless liquid heating apparatus is provided. The control assembly includes a cordless base connector for mounting to a cordless power base and an adaptor for mounting to a liquid heating vessel. The adaptor includes a pin including first and second electrical contacts arranged to connect with corresponding first and second electrical contacts in the cordless base connector. The adaptor further includes a third electrical contact having an annular form extending around the pin, and arranged to connect with a corresponding third electrical contact in the cordless base connector. The adaptor also includes a fourth electrical contact having an annular form extending around the third electrical contact, and arranged to connect with a corresponding fourth electrical contact in the base connector. The third and fourth electrical contacts and the corresponding third and fourth electrical contacts are configured to provide a live and neutral connection to the liquid heating vessel.

This application is entitled to the benefit of, and incorporates by reference essential subject matter disclosed in PCT Application No. PCT/GB2024/050963 filed on Apr. 12, 2024, which claims priority to GB Patent Application No. 2305464.6 filed Apr. 13, 2023 and CN Patent Application No. 202310540178.4 filed May 12, 2023, which are hereby incorporated by reference in their entireties.

### BACKGROUND OF THE INVENTION

### 1. Technical Field

The present invention relates to control assemblies for cordless liquid heating apparatuses, to support structures forming part of such control assemblies and to methods of manufacturing at least adaptors of such control assemblies.

### 2. Background Information

Cordless liquid heating apparatuses typically comprise a liquid heating vessel which can be seated on a cordless power base. Such cordless liquid heating apparatuses often comprise a control assembly which comprises an adaptor arranged in a liquid heating vessel and a cordless base connector arranged in a cordless power base. When the liquid heating vessel is seated on the cordless power base, the adaptor and cordless base connector mate together facilitating the transfer of power and/or data between the liquid heating vessel and the cordless power base. Two of the main types of control assembly which are used include 3-pole and 5-pole assemblies. 3-pole assemblies typically provide a live, neutral and earth connection, whereas 5-pole assemblies typically provide a live, neutral, earth, and data connection (using two-poles of the assembly).

The control assemblies discussed above are often in the form of 360° assemblies whereby the liquid heating vessel can be placed onto the cordless power base at any angular position. To facilitate this arrangement, adaptors in the prior art typically comprise a central contact pin surrounded by a number of radially spaced annular contacts. An adaptor of a 3-pole assembly comprises a central pin, surrounded by a first annular contact radially spaced from the pin, as well as a second annular contact radially spaced from the first annular contact. 5-pole adaptors typically comprise the same pin, first and second annular contacts as the 3-pole adaptors, as well as two further annular contacts each radially spaced from the first and second annular contacts. In such 5-pole adaptors, the width of the adaptor can become relatively large due to the need to provide sufficient space between each of the contacts. A support structure, of the adaptor, which supports the contacts may thus be relatively wide. The relatively large width of the support structure may mean that the support structure, and thus the adaptor, has an increased manufacturing cost.

### SUMMARY

The present invention aims to address or at least mitigate at least one of the problems outlined above and when viewed from a first aspect provides a control assembly, for a cordless liquid heating apparatus comprising a liquid heating vessel and a cordless power base, the control assembly comprising: a cordless base connector for mounting to the cordless power base; and an adaptor for mounting to the liquid heating vessel, the adaptor configured to mate with the cordless base connector when the liquid heating vessel is seated on the cordless power base, wherein the adaptor comprises: a pin comprising first and second electrical contacts arranged to connect with corresponding first and second electrical contacts in the cordless base connector; a third electrical contact having an annular form extending around, and radially displaced from, the pin, and arranged to connect with a corresponding third electrical contact in the cordless base connector; and a fourth electrical contact having an annular form extending around, and radially displaced from, the third electrical contact, and arranged to connect with a corresponding fourth electrical contact in the cordless base connector; wherein the third and fourth electrical contacts in the adaptor together with the corresponding third and fourth electrical contacts in the cordless base connector are configured to provide a live and neutral connection to the liquid heating vessel.

In contrast to prior art control assemblies which utilize a pin carrying a single electrical contact, the control assembly according to the present invention utilizes a pin carrying both first and second electrical contacts. The Applicant has recognized that by including an extra electrical contact with the pin, the number of radially displaced, e.g. annular contacts, which surround the pin may be reduced. The radial extent of the outermost electrical contact of the adaptor, and thus the corresponding electrical contact in the cordless base connector, may therefore be reduced in comparison to prior art control assemblies. This, may, reduce the overall footprint of the adaptor and the cordless base connector.

In addition to the above, by incorporating a second electrical contact with the pin, when compared to typical prior art control assemblies, this may remove one of the annular contacts which would otherwise surround the pin. As will be appreciated by those skilled in the art, the amount of material required to form the contact on the pin may be significantly less than the amount of material required to form such an annular contact. The control assembly according to the present invention may thus use less material for forming the electrical contacts. As the contacts are typically formed from a silver-plated copper, or copper alloy, this may represent a significant cost reduction in the manufacture of the control assembly.

Further, in the control assembly according to the present invention, the third and fourth annular electrical contacts together with the corresponding third and fourth electrical contacts in the cordless base connector are configured to provide live and neutral connections to the liquid heating vessel. As such, one of the third and fourth annular contacts may be considered to be a live contact and the other of the third and fourth annular contacts may be considered to be a neutral contact. The same applies to the corresponding third and fourth electrical contacts in the cordless base connector. The Applicant has appreciated that utilizing the third and fourth annular electrical contacts to provide a live and neutral connection is advantageous over using the first and second contacts which form part of the pin. Specifically, as the first and second contacts on the pin may be relatively close together, due to being part of the single pin, use of such contacts as live and neutral contacts may result in arcing and tracking problems. In contrast, use of the third and fourth annular electrical contacts may advantageously avoid such arcing and tracking problems. When the adaptor is mounted to a liquid heating vessel, the third and fourth electrical contacts may be connected to an electrically powered component, e.g. a heating element, within the liquid heating appliance. Similarly, when the cordless base connector is mounted to a cordless power base, the corresponding third and fourth electrical contacts may be connected to a live and neutral power feed into the cordless power base.

The adaptor set out above may be considered to be a cordless adaptor. Similarly, because each of the adaptor and cordless base connector comprise electrical contacts, the adaptor may be considered to be an electrical adaptor, e.g. a cordless electrical adaptor, and the cordless base connector may be considered to be a cordless base electrical connector.

In some countries there is no requirement to provide an earth connection to the liquid heating vessel. The control assembly set out above may therefore include sufficient contacts to facilitate suitable functioning of the liquid heating vessel. However, in other countries, the presence of an earth contact is necessary to meet standard requirements. Accordingly, in some embodiments, the adaptor further comprises a fifth electrical contact radially displaced from the pin and arranged to connect with a corresponding fifth electrical contact in the cordless base connector, and wherein the fifth electrical contact is configured to provide an earth connection for the liquid heating vessel. Such a control assembly thus provides an earth connection for the liquid heating vessel in countries where this is required. The fifth electrical contact may be arranged at any suitable position within the adaptor, and similarly the corresponding fifth electrical contact may be arranged at any suitable position in the cordless base connector. However, in a set of embodiments, the fifth electrical contact is displaced radially outwards of the fourth electrical contact. The fifth electrical contact, which provides the earth connection, may thus be the most radially outward contact. Where the fifth electrical contact is the most radially outward contact, and has an annular form, the fifth electrical contact may be the largest of all the contacts. In this instance, having the fifth electrical contact as the earth contact may again reduce the cost of materials in the control assembly as the earth contact may be made from brass which is less expensive than silver plated copper, which may be used for the live and neutral contacts. As the earth contact is only used in fault conditions, and doesn't switch current, it does not need to be silver plated.

The fifth electrical contact and corresponding fifth electrical contact may have any suitable form. In a set of embodiments, the fifth electrical contact has an annular form. In such embodiments, the corresponding fifth electrical contact may be a point-like contact. In other embodiments, the fifth electrical contact is a point-like contact and wherein the corresponding fifth electrical contact has an annular form. In being a point-like contact, this is intended to mean that the respective contact extends to a limited angular extent around the connector or adaptor. The point-like contact thus only touches a limited angular portion of the annular form of the contact which it touches. Nonetheless, the provision of one contact which has an annular form together with a point-like contact will facilitate connection therebetween irrespective of the angular orientation at which the connector and adaptor are mated. The corresponding first, second, third and fourth contacts in the cordless base connector may also be point-like contacts. The use of an annular contact which mates with a point-like contact may reduce the total amount of material required to provide the electrical connection, at least when compared to having both contacts in a given annular form.

The third electrical contact, fourth electrical contact, and fifth electrical contact (where provided), may all extend around a common central axis. In other words, they may be co-axial. This central axis may be a central axis extending through the pin, e.g. the center of the pin.

The first and second electrical contacts in the adaptor may be used for any suitable purpose. For example, in addition to the third and fourth electrical contacts, the first and second electrical contacts may also be utilized for power transfer, but at a different voltage to the power transfer via the third and fourth electrical contacts. For example, the first and second electrical contacts may be used to transfer power at a voltage of 12 V, e.g. to a pump within the liquid heating vessel. However, in a set of embodiments, the first and second electrical contacts in the adaptor together with the corresponding first and second electrical contacts in the cordless power base provide a signal connection for transferring data between the adaptor and cordless base connector. The first electrical contact may thus be considered to be a first signal contact and the second electrical contact may be considered to be a second signal contact. The transfer of data over the first and second electrical contacts together with the corresponding first and second electrical contacts may only use a relatively low electrical current and/or potential difference. As such, despite the first and second electrical contacts being provided together on the pin, the risk of arcing may be relatively low.

The first and second electrical contacts may provide for any suitable data transfer. For example, the cordless power base may comprise a controller and the liquid heating vessel may comprise an electronic component, e.g. a temperature sensor. The first and second electrical contacts, together with the corresponding first and second electrical contacts, may thus facilitate the transfer of data between the electronic component in the liquid heating vessel and the controller in the cordless power base.

In a set of embodiments, the adaptor forms part of a control arrangement for mounting to the liquid heating vessel. The adaptor may, in some embodiments, be integrally formed with, or attached to, the control arrangement. The control arrangement may comprise means for at least partially controlling operation of the liquid heating vessel. The control arrangement may comprise at least one temperature monitoring means arranged to monitor a temperature of the liquid heating vessel, e.g. of a base of a heating chamber of the liquid heating vessel. The temperature monitoring means may, for example, comprise a thermally sensitive actuator configured to operate a switch at a predetermined temperature. The switch may be arranged to cut the supply of power to the liquid heating vessel, e.g. to a heating element therein.

In a further set of embodiments, the control arrangement comprises an electronic component to which the first and second electrical contacts of the pin are electrically connected. The first and second electrical contacts may thus facilitate power and/or data transfer between the electronic component and a further component arranged in the cordless power base.

The electronic component may be arranged in any suitable manner on the control arrangement. For example, the electronic component may be mounted to an upper side of the control arrangement, and connected to the first and second electrical contacts by respective electrical wires. In another set of embodiments, the control arrangement comprises a bracket, extending away from a center of the control arrangement, and wherein the electronic component is mounted to an end of the bracket. This arrangement may be particularly suitable when it is not desired or necessary for the electronic component to be mounted near the center of the control arrangement.

In another set of embodiments, the pin and electronic component are formed as a module which is inserted into the adaptor. The module may comprise a mounting body to which the electronic component, as well as components of the pin, can be mounted to. For example, the first and second contacts may be mounted to the mounting body and electrically connected to the electronic component, which may also be mounted to the mounting body. The mounting body may, in some embodiments, comprise mounting features which function to secure the electronic component in place on the mounting body. The mounting body may comprise a pin-shaped portion configured to receive the first and second electrical contacts. The pin-shaped portion may comprise a hollow core, shaped to receive the first electrical contact therein. The second electrical contact may be arranged on an outside surface of the pin-shaped portion. The material of the pin-shaped portion may act to electrically insulate the first and second contacts. The mounting body may be made from an electrically insulative material. Providing the electronic component and pin together as a module may allow the pin and electronic component to be easily inserted into and mounted within the control assembly.

The electronic component of any of the embodiments above may comprise any appropriate electronic component. In a set of embodiments, the electronic component comprises a temperature sensor. The temperature sensor may, for example, comprise a thermistor, e.g. a negative temperature coefficient (NTC) thermistor. In embodiments wherein the electronic component and contact pin are formed as part of a module, where the electronic component is a temperature sensor, this may ensure consistent and appropriate positioning of the temperature sensor. Of course, the electronic component may comprise any other suitable electronic component. For example, the electronic component may comprise a motor, a solenoid, a relay or a display.

The third and fourth electrical contacts, which provide a live and neutral connection for the liquid heating vessel, may be spaced from one another by an air gap sufficient so as to minimize the likelihood of arcing occurring between the two contacts. However, the Applicant has recognized that separating the third and fourth electrical contacts with an air gap may increase the overall size of the adaptor. Accordingly, in a set of embodiments, the third and fourth electrical contacts are separated by an annular insulating member, wherein the third electrical contact is in contact with an inward facing surface of the annular insulating member and wherein the fourth electrical contact is in in contact with an outward facing surface of the annular insulating member. The Applicant has appreciated that the use of an insulating member, i.e. a body of material, as opposed to spacing the third and fourth electrical contacts in air, may allow the third and fourth electrical contacts to be positioned closer to one another. In other words, the thickness of the insulating member may be less than the air gap required to suitably space the third and fourth electrical contacts. The use of the insulating member may thus further reduce the footprint of the adaptor, and of the cordless base connector. In other embodiments, the third and fourth electrical contacts may be separated by an annular insulating member, but need not necessarily be in contact with the inward facing surface and outward facing surface. Instead, the third electrical contact may be arranged on a first side of the annular insulating member and the fourth electrical contact may be arranged on the opposite side of the annular insulating member. This arrangement may nonetheless use less space than merely separating the contacts by air.

In a further set of embodiments, the adaptor comprises an axis extending through the contact pin, and wherein the insulating member extends to a greater axial extent, in the direction towards an exposed end of the contact pin, than the third and fourth electrical contacts. The insulating member thus effectively extends further than the third and fourth electrical contacts increasing the distance in free air between the third and fourth electrical contacts. This may further minimize the risk of arcing between the third and fourth electrical contacts.

In embodiments comprising a control arrangement, the control arrangement may comprise a support structure to which the pin and third and fourth (and fifth, where provided) electrical contacts are mounted to, and the annular insulating member may be integrally formed with the support structure. The support structure may be formed from injection molded plastic.

The first and second electrical contacts may be provided on the pin in any suitable manner. In a set of embodiments, the pin comprises an insulating member arranged between the first and second electrical contacts. The insulating member may act to electrically isolate each of the first and second electrical contacts from one another. The insulating member may have any suitable form which may depend on the relative arrangement of the first and second electrical contacts on the pin. In the embodiments wherein contact pin and electronic component are provided as a module, the insulating member may be provided by the mounting body of the module. The first and second electrical contacts may be mounted to the mounting body.

The first and second electrical contacts may be isolated from one another in any suitable arrangement. In a set of embodiments, the first and second electrical contacts are separated from one another along an axis of the pin. In being separated from one another, the first and second electrical contacts may be considered to be electrically separated, i.e. isolated, from one another. Separating the first and second electrical contacts along an axis of the pin may advantageously allow the first and second contacts to mate with corresponding first and second electrical contacts in the cordless base connector irrespective of the angular orientation at which the adaptor is placed on the cordless base connector. The corresponding first and second electrical contacts in the cordless base connector may have a suitable form so as to touch the first and second electrical contacts when the adaptor and cordless base connector are mated together. Each of the first and second electrical contacts may extend around the entire pin, e.g. around the entire circumference thereof. In some embodiments, the first electrical contact protrudes from a tip of the pin, and the second electrical contact extends around a circumference of the pin.

In some embodiments, the first and second electrical contacts are separated from one another around an axis of the pin. Separating the first and second electrical contacts around the axis of the pin may provide another means for electrically isolating the first and second electrical contacts from one another. It may, also, still be possible to facilitate mating of the first and second electrical contacts with corresponding first and second electrical contacts in the cordless power base irrespective of the angular position at which the adaptor is placed on the cordless power base.

The pin may have any suitable cross-sectional shape. In a set of embodiments, the pin has a substantially cylindrical shape. A pin with a substantially cylindrical, e.g. cylindrical, shape may advantageously facilitate positioning of the adaptor at any angular position on the cordless base connector. In some embodiments, a tip of the pin may be pointed. A pointed tip may again facilitate the placement of the adaptor on the cordless base connector.

In some embodiments, the control assembly is a 360° cordless control assembly. A 360° cordless control assembly may advantageously allow the adaptor (and thus a liquid heating vessel into which it is affixed) to be placed on the cordless base connector (and thus a cordless power base) at any angular orientation. This may improve ease of use of the apparatus. The adaptor may thus be a 360° adaptor and the cordless base connector may be a 360° cordless base connector. Such an adaptor and cordless base connector may each be substantially cylindrical, e.g. cylindrical, in shape which may facilitate mating at any angular orientation.

In some embodiments, the pin is arranged centrally on the adaptor. Arranging the pin centrally on the adaptor may again improve ease of use when the assembly is mounted to a liquid heating vessel and cordless power base.

The present invention extends to a cordless liquid heating apparatus comprising a control assembly. Thus, when viewed from a second aspect there is provided a cordless liquid heating apparatus comprising: a cordless power base for connection to a mains power supply; a liquid heating vessel configured to be seated on the cordless power base; and a control assembly according to any of the aspects or embodiments set out above, wherein the adaptor is mounted to the liquid heating vessel and wherein the cordless base connector is mounted to the cordless power base.

In being configured seated on the cordless power base, this is intended to mean that the liquid heating vessel can be lifted away from, and seated back down on, the cordless power base. As the control assembly may have a smaller extent, the size of the liquid heating vessel and/or the cordless power base may be reduced when compared to those in the prior art.

In a further set of embodiments, the liquid heating vessel comprises a chamber for receiving a volume of a liquid to be heated, and a heating element for heating the liquid within the vessel, and wherein the third and fourth electrical contacts are electrically connected to the heating element. The cordless power base may comprise a power cable, suitable for connection to a mains power supply, and the corresponding third and fourth electrical contacts therein may be connected to live and neutral connections of the power cable. Of course, the liquid heating vessel may comprise any other suitable electrically powered component, e.g. an electric motor, relay, solenoid, display, etc. and the third and fourth electrical contacts may be electrically connected to such a component.

The liquid heating vessel may comprise a first electronic component to which the first and second contacts of the adaptor are connected and the cordless power base comprises a second electronic component to which the corresponding first and second contacts in the cordless base connector are connected. The first and second electrical contacts, together with their corresponding first and second electrical contacts may thus provide an electrical connection between the first and second electronic components. The first electronic component may comprise: a temperature sensor, a motor etc. The second electronic component may comprise an electronic controller. The first and second electrical contacts, together with the corresponding first and second electrical contacts, may thus facilitate the transfer of data between the first and second electronic components.

As set out in the background section above, 3-pole and 5-pole control assemblies are known in the prior art. The adaptors and cordless base connectors of such control assemblies each comprise a support structure which carries each of the electrical contacts. In prior art control assemblies, different support structures have to be formed for the 3-pole and 5-pole control assemblies. The Applicant has recognized that it may be inefficient to produce separate support structures for the different types of control assembly. Accordingly, when viewed from a third aspect, the present invention provides a support structure, for forming at least part of an adaptor configured to provide an electrical connection with a corresponding cordless base connector, the support structure comprising: a pin receiving portion capable of receiving a plurality of different types of pins, said pins comprising at least a first pin carrying a first electrical contact and a second pin carrying a first electrical contact and a second electrical contact; a first annular contact receiving portion capable of receiving a third electrical contact having an annular form; a second annular contact receiving portion capable of receiving a fourth electrical contact having an annular form; and a third receiving portion capable of receiving a fifth electrical contact.

Accordingly, the Applicant has recognized that a single support structure may be used to form a variety of different adaptors depending on which pin is inserted into the structure and/or which of the third, fourth and fifth electrical contacts are received in the support structure. The pin receiving portion being capable of receiving a plurality of different types of pins is intended to mean that, a number of different pins can be interchangeably inserted into the pin receiving portion, but only a single pin is received therein at any given time.

As an example, a first pin carrying a first electrical contact may be inserted into the pin receiving portion, a third electrical contact may be inserted into the first annular contact receiving portion and a fourth electrical contact may be inserted into the second annular contact receiving portion so as to form a 3-pole adaptor. In contrast, a 5-pole adaptor may be formed by instead placing a second pin carrying a first electrical contact and a second electrical contact into the pin receiving portion, a third electrical contact into the first annular contact receiving portion, a fourth electrical contact into the second annular contact receiving portion, and a fifth electrical contact in the third receiving portion.

The receiving portions may have any suitable form/shape so as to be suitable for receiving their respective contact. In a set of embodiments, the pin receiving portion comprises an aperture extending through the support structure into which the pin may be inserted. The pin receiving portion may comprise a retention feature configured to engage with the pin, or a member connected thereto, so as to suitably secure the pin in position. The first annular contact receiving portion, second annular contact receiving portion and third receiving portion may each comprise a structure which may have a corresponding annular shape. For example, each of such portions may comprise an annular wall to which the respective electrical contact may be mounted. Each of such portions may also, or instead, comprise apertures extending into the support structure shaped to receive protrusions or tabs extending from the respective electrical contacts. Such apertures may serve to at least locate the respective electrical contacts.

In a set of embodiments, the first annular contact receiving portion, the second annular contact receiving portion and third receiving portion are radially displaced from one another relative to the pin receiving portion. Radially displacing the first, second annular contact receiving portions and the third receiving portion may suitably separate the respective electrical contacts within the support structure, when they are mounted thereto, such that each of the contacts is electrically isolated from one another.

In another set of embodiments, the support structure only comprises the pin receiving portion, first annular receiving portion, second annular receiving portion and third receiving portion for receiving electrical contacts. Said electrical contacts are those which are suitable for connection with corresponding electrical contacts in a cordless base connector with which the adaptor may be mated. According to such embodiments, the support structure may only be capable of receiving up to five electrical contacts (assuming the pin is capable of carrying up to two electrical contacts).

The support structure may have any suitable form and be formed from any suitable material. In a set of embodiments, the support structure is formed of a plastic body. The support structure may, for example, comprise an injection molded plastic body. In some embodiments, the third receiving portion may capable of receiving a fifth electrical contact having an annular form.

The Applicant has recognized that by using the support structure set out above a novel method of manufacturing/assembling an adaptor may be employed. Thus, when viewed from a fourth aspect, there is provided a method of forming at least an adaptor of a control assembly, the adaptor being configured for mounting to a liquid heating vessel, the method comprising the steps of: forming a support structure according to any of the embodiments set out above; determining whether a pin is required and when a pin is required: selecting one of: a first pin carrying a first electrical contact or a second pin carrying a first electrical contact and a second electrical contact; and inserting the selected pin into the pin receiving portion; inserting a third electrical contact having an annular form into the first annular contact receiving portion; and inserting a fourth electrical contact having an annular form into the second annular contact receiving portion.

Use of the support structure and the method set out above may advantageously allow a number of different adaptors to be quickly and easily manufactured and assembled.

In some countries no earth connection may be required. In such instances, it may be determined that no pin is required. In this case, when it is determined that no pin is required, no pin is inserted into the support structure. As such, only the further steps of inserting a third and fourth electrical contact into the support structure may be performed. This may form a 2-pole adaptor. It may be the case that a pin is always required, e.g. so as to meet certain electrical standards. As such, the step of determining whether a pin is required may be omitted. The step of selecting and inserting the selected pin may nonetheless still be included.

When a pin is required, and the first pin is selected, e.g. because it is not required for the adaptor to be capable of facilitating data transfer, the method forms a 3-pole adaptor. In contrast, in the situation whereby the second pin is selected and inserted into the pin receiving portion, the method forms a 4-pole adaptor. The third electrical contact and fourth electrical contact may provide for live and neutral connection. When selecting the first pin, the first electrical contact may provide for earth connection, whereas when selecting the second pin, the first and second contacts may provide for data connection.

In a further set of embodiments, the method further comprises inserting a fifth electrical contact into the third receiving portion. Where a second pin comprising first and second electrical contacts is selected and inserted, such embodiments form a 5-pole adaptor. The fifth electrical contact may provide for an earth connection to the liquid heating vessel in which the adaptor is mounted.

In a set of embodiments, the second pin carrying the first electrical contact and the second electrical contact is part of a module which includes the second pin and an integrated electronic component electrically connected to the first and second electrical contacts of the second pin. Such a pin module may simplify the assembly process as the pin, contacts and integrated electronic component may quickly and easily be inserted into the support structure.

The Applicant has recognized that the above advantages are not necessarily limited to the formation of the adaptor. Thus, when viewed from a further aspect there is provided a connector support structure, for forming at least part of a cordless base connector configured to provide an electrical connection with a corresponding adaptor, the support structure comprising: a first contact receiving portion configured to receive a first corresponding electrical contact, a second contact receiving portion configured to receive a second corresponding electrical contact, a third contact receiving portion configured to receive a third corresponding electrical contact, a fourth contact receiving portion configured to receive a fourth corresponding electrical contact and a fifth contact receiving portion configured to receive a fifth corresponding electrical contact.

The connector support structure may thus be capable of receiving up to five electrical contacts. Any number of electrical contacts may be mounted to the connector support structure so as to form a desired cordless base connector.

In some embodiments, the support structure comprises a centrally arranged cylindrical boss with a hollow core and an annular wall spaced from and surrounding the cylindrical boss to define an annular cavity between the cylindrical boss and the annular wall, wherein the first and second contact receiving portions are arranged within the hollow core of the cylindrical boss, wherein the second and third contact receiving portions are arranged at a base of the hollow core, and wherein the fifth contact receiving portion is arranged in an outward facing surface of the annular wall. The various contact receiving portions may thus be suitably arranged to position contacts for mating with the corresponding contacts in the adaptor.

The support structure may be formed from a plastic material. The support structure may be injection molded.

According to a further aspect of the present invention there is provided a method of forming a cordless base connector of a control assembly, the cordless base connector being configured for mounting in a cordless power base, the method comprising the steps of: forming a connector support structure according to any of the embodiments set out above; determining how many electrical contacts are required within the cordless base connector; inserting at least two of a first, second, third, fourth and fifth corresponding electrical contact into the respective first, second, third, fourth and fifth electrical contact receiving portions.

A number of different cordless base connectors may thus be formed using a single connector support structure. The number of parts required to manufacture different cordless base connectors may thus be reduced.

According to a further aspect of the present invention there is provided a control assembly, for a cordless liquid heating apparatus comprising a liquid heating vessel and a cordless power base, the control assembly comprising: a cordless base connector for mounting to the cordless power base; and an adaptor which forms part of a control arrangement for mounting to the liquid heating vessel, wherein the adaptor is configured to mate with the cordless base connector when the liquid heating vessel is seated on the cordless power base, and wherein the adaptor comprises: a pin comprising first and second electrical contacts arranged to connect with corresponding first and second electrical contacts in the cordless base connector; a third electrical contact having an annular form extending around, and radially displaced from, the pin, and arranged to connect with a corresponding third electrical contact in the cordless base connector; and a fourth electrical contact having an annular form extending around, and radially displaced from, the third electrical contact, and arranged to connect with a corresponding fourth electrical contact in the cordless base connector; wherein the third and fourth electrical contacts in the adaptor together with the corresponding third and fourth electrical contacts in the cordless base connector are configured to provide a live and neutral connection to the liquid heating vessel.

Any of the features of the embodiments of the earlier aspects of the invention may equally be applied to the above aspect of the invention.

In any of the aspects or embodiments described above, the liquid heating vessel may be suitable for heating any appropriate liquid, e.g. water, milk, tea, coffee etc. The liquid heating apparatus of any of the embodiments set out above may be a domestic countertop liquid heating apparatus, e.g. in the form of a kettle, coffee maker, milk frother etc.

### BRIEF DESCRIPTION OF THE DRAWINGS

Some preferred embodiments of the present invention will now be described, by way of example, only, and with reference to the accompanying drawings, in which:

FIG. 1 is a schematic view of a cordless liquid heating apparatus in accordance with an embodiment of the present invention;

FIG. 2 is a perspective view of a control assembly in accordance with an embodiment of the present invention;

FIG. 3 is a perspective view of the underside of the control arrangement shown in FIG. 2;

FIG. 4 is a cut-away view through the control arrangement shown in FIG. 2;

FIG. 5 is a view of the support structure of the control arrangement shown in FIG. 2;

FIG. 6 is a perspective view of the underside of the support structure shown in FIG. 5, showing the adaptor therein;

FIG. 7 is an underside plan-view of the support structure shown in FIG. 5;

FIG. 8 is a topside plan-view of the support structure shown in FIG. 5;

FIG. 9 is a cut-away view through the support structure shown in FIG. 5;

FIG. 10 is a perspective view of the control arrangement shown in FIG. 2, with a number of components hidden so as to show the live and neutral electrical connections;

FIG. 11 is a view of a module comprising a pin and an electronic component in accordance with an embodiment of the present invention;

FIG. 12 is a cut-away view through the module shown in FIG. 11;

FIG. 13 is a perspective view of a mounting body of the module shown in FIG. 11;

FIG. 14 is a perspective view of the second electrical contact shown in earlier Figs.;

FIG. 15 is a perspective view of the first electrical contact shown in earlier Figs.;

FIG. 16 is perspective view of the cordless base connector shown in FIG. 2;

FIG. 17 is a cut-away view through the cordless base connector, showing the corresponding first and second electrical contacts;

FIG. 18 is a perspective view of a control arrangement in accordance with another embodiment of the present invention;

FIG. 19 is a perspective view of a control arrangement in accordance with a further embodiment of the present invention;

FIG. 20 is a view of the control arrangement shown in FIG. 18, with a number of components thereof hidden so as to reveal the electrical connections within the control arrangement;

FIG. 21 is another view of the underside of the control arrangement shown in FIG. 18, with further components hidden to show the electrical connections;

FIG. 22 is a view of a control assembly in accordance with another embodiment of the present invention whereby the adaptor thereof is a 3-pole adaptor;

FIG. 23 is a view of the underside of the control arrangement shown in FIG. 22 showing the three contacts of the adaptor thereof;

FIG. 24 shows a view of the control arrangement with a number of the components thereof hidden to show the electrical connections within the control arrangement;

FIG. 25 is a perspective view of a 3-pole cordless base connector;

FIG. 26 shows a perspective view of a pin of an adaptor according to another embodiment of the present invention; and

FIG. 27 shows a flowchart illustrating a method of forming an adaptor in accordance with an embodiment of the present invention.

### DETAILED DESCRIPTION

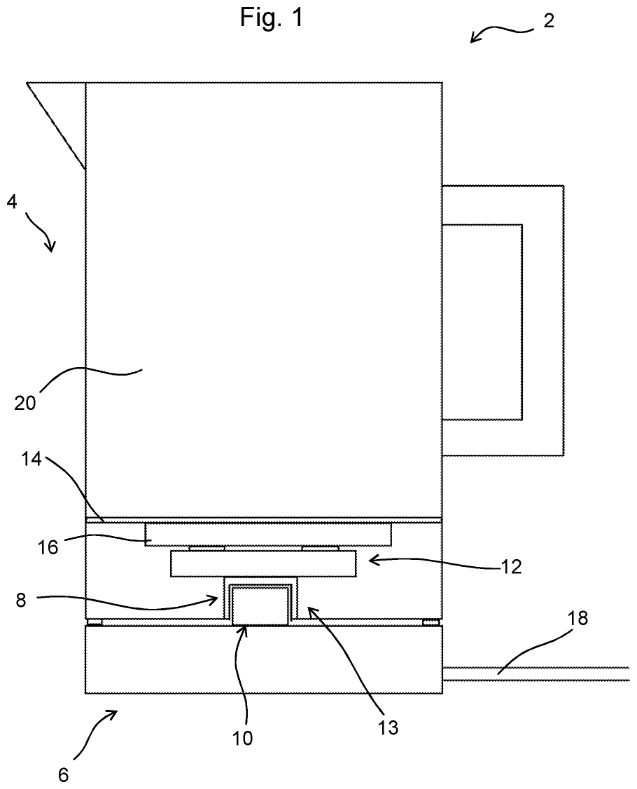

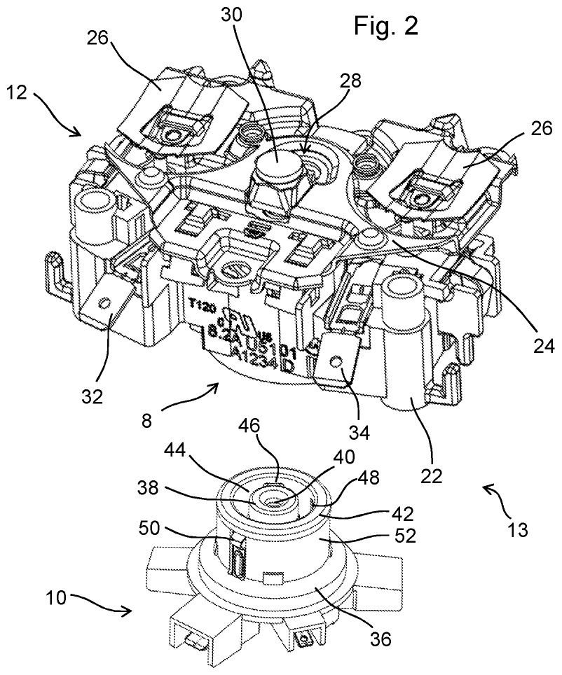

FIG. 1 is a schematic view of a cordless liquid heating apparatus 2 in accordance with an embodiment of the present invention. The cordless liquid heating apparatus 2 comprises a liquid heating vessel 4 and a cordless power base 6. The liquid heating vessel 4 comprises an adaptor 8 and the cordless power base comprises a cordless base connector 10 (hereinafter “connector 10”). The adaptor 8 and connector 10 together form a control assembly 13 in accordance with an embodiment of the present invention. In the embodiment depicted, the adaptor 8 is attached to, and forms part of, a control arrangement 12 which is mounted within the liquid heating vessel 4. The liquid heating vessel comprises a heated base 14 which is heated by a heating element 16. The heated base 14 at least partially defines a chamber 20 in which a liquid, e.g. water, is received and heated during operation of the apparatus 2. The cordless power base 6 comprises a power cord 18 which may be connected to a suitable, e.g. mains, power supply (not shown). The power cord 18 may be electrically connected to suitable components within the cordless power base 6 and directly, or indirectly, to the connector 10 provided therewith.
FIG. 2 shows a perspective view of a control assembly 13, in accordance with an embodiment of the present invention. The control assembly 13 comprises a cordless base connector 10 for mounting to the cordless power base 6 and an adaptor 8 for mounting to the liquid heating vessel 4. In the embodiment depicted, the control assembly 13 is in the form of a 5-pole control assembly 13. In other words, each of the adaptor 8 and connector 10 comprise five electrical contacts.

In the embodiment depicted, the adaptor 8 is provided together with the control arrangement 12. The control arrangement 12 comprises a support structure 22 in which the adaptor 8 is formed. The support structure 22 may be formed from injection molded plastic. A metal plate 24 may be attached to the top of the support structure 22 so as to support further components. The control arrangement 12 comprises a number of thermally sensitive actuators 26 which may be arranged to monitor the temperature of a component, e.g. a heating element 16, within the liquid heating vessel 4. The thermally sensitive actuators 26 may act to open an electrical circuit (not visible) within the control arrangement 12 when a predetermined temperature is detected.

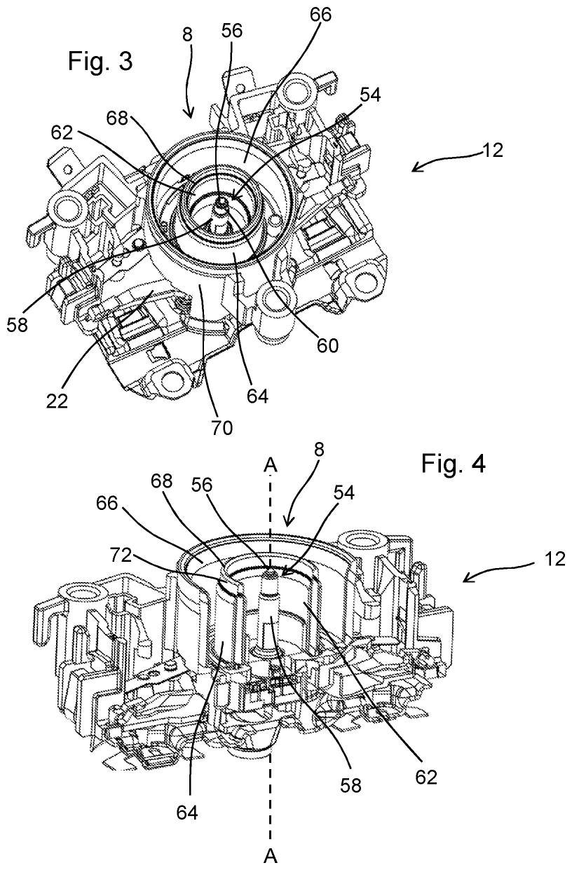

A module 28 comprising a temperature sensor 30 is also mounted within the control arrangement 12. The module 28 is mounted such that the temperature sensor 30 is in a fixed position relative to the support structure 22 of the control arrangement 12. As visible in FIG. 2, the control arrangement 12 comprises a first electrical tab 32 and a second electrical tab 34. Whilst not visible in this Figure, each of these first and second electrical tabs 32, 34 may be connected to a respective one of the third and fourth electrical contacts within the adaptor 8. These contacts can be seen in FIG. 3. The first and second electrical tabs 32, 34 may be connected to an electrically powered component, e.g. the heating element 16, within the liquid heating vessel 4.

The connector 10 comprises a connector support structure 36 to which a number of corresponding electrical contacts are mounted. The connector support structure 36 defines a central boss 38 with an opening 40 therein. The connector support structure 36 further comprises a surrounding, annular, wall 42 spaced from the central boss 38 and which defines an annular aperture 44. Whilst not visible, corresponding first and second electrical contacts are arranged within the cylindrical opening 40, a third corresponding electrical contact 46 and a fourth corresponding electrical contact 48 are arranged in the annular aperture 44 and a fifth corresponding electrical contact 50 is arranged on an outermost wall 52 of the connector support structure 36.

Further details of the adaptor 8 will now be described. FIG. 3 shows a perspective view of the underside of the control arrangement 12 shown in FIG. 2. The adaptor 8 can be seen more clearly in this Figure. As visible in this Figure, in some embodiments, the adaptor 8 comprises a pin 54. The pin comprises a first electrical contact 56 and a second electrical contact 58. The first electrical contact 56 extends from a tip of the pin 54 and the second electrical contact 58 extends along and around the pin 54. The first and second electrical contacts 56, 58 are separated from one another by an insulating member 60 which functions to electrically insulate the first and second electrical contacts 56, 58 from one another. The pin 54 may be arranged centrally within the adaptor 8, as depicted. In some embodiments, as shown in FIG. 3, the pin 54 is substantially cylindrical, e.g. cylindrical, in shape. Of course, the pin 54 may have any other suitable shape.

The adaptor 8 further comprises a third electrical contact 62, a fourth electrical contact 64 and a fifth electrical contact 66. Each of the third, fourth and fifth electrical contacts 62, 64, 66 have an annular form. As visible in FIG. 3, the third and fourth electrical contacts 62, 64 may be separated from one another by an annular insulating member 68. As visible in FIG. 3, the support structure 22 defines an outermost annular wall 70. The fifth electrical contact 66 is mounted against an inside surface (not visible in this Figure) of this outermost annular wall 70. As also apparent from FIG. 3, the third, fourth and fifth electrical contacts 62, 64, 66 are each radially spaced, by a different extent, from the pin 54.

Whilst not visible in FIG. 3, the third and fourth electrical contacts 62, 64 provide a live and neutral connection within the adaptor 8. In other words, they facilitate the supply of electrical power into the adaptor 8 and to an electrically powered component connected thereto. When the adaptor 8 is mounted to the liquid heating vessel 4, the third and fourth electrical contacts 62, 64 may ultimately be connected to an electrically powered component, e.g. the heating element 16.

In a similar manner, whilst not visible in FIG. 3, the fifth electrical contact 66 may provide an earth connection within the adaptor 8, the control arrangement 12 and the liquid heating vessel 4 into which the control arrangement 12 is mounted.

The control assembly 13 may be in the form of a 360° cordless control assembly whereby the adaptor 8 can be placed at any angular orientation on the cordless base connector 10. This is achieved by having an adaptor 8 which has a cylindrical profile and a cordless base connector which has a corresponding and complementary cylindrical profile.

FIG. 4 shows a cut-away view through the control arrangement 12 focusing on the adaptor 8 thereof. The pin 54, together with the first and second electrical contacts 56, 58, along with the third, fourth and fifth electrical contacts 62, 64, 66 can be seen more clearly in this Figure. As visible in FIG. 4, the adaptor 8 generally extends along an axis as shown by dashed line A-A. This axis extends through the center of the adaptor 8 and thus through the center of the pin 54.

In some embodiments, as shown in FIG. 4, the annular insulating member 68 has a greater extent along the axis A-A, than the third and fourth electrical contacts 62, 64. As a result, this forms an annular rim 72 at the top of the annular insulating member 68 on which there is no electrical contact present. This increases the separation in free air between the third and fourth electrical contacts 62, 64, thereby further minimizing the chance of arcing occurring therebetween.

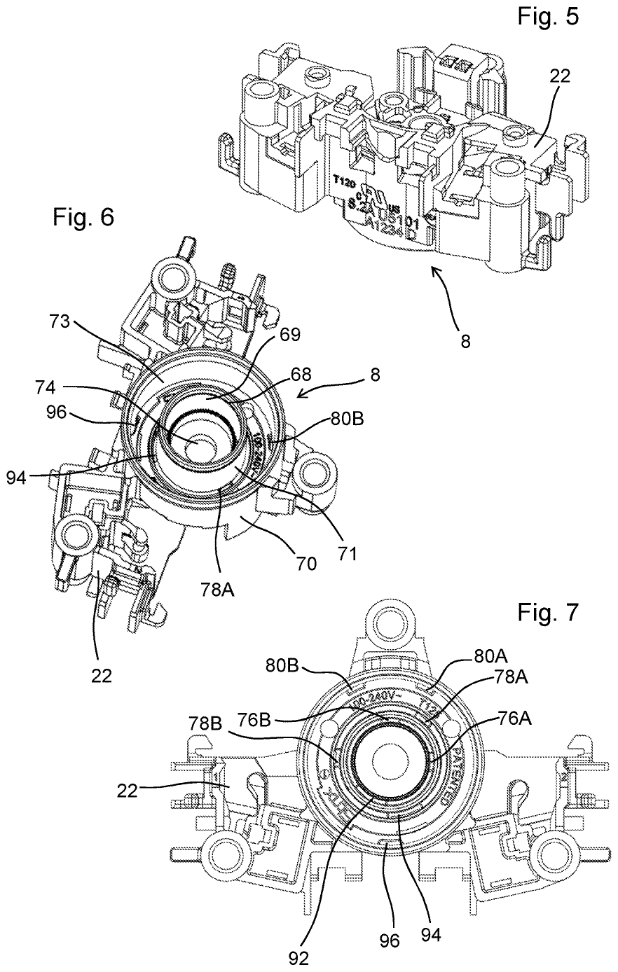

FIG. 5 shows a perspective view of the support structure 22 of the control arrangement 12 which comprises the adaptor 8 formed therein. The support structure 22 is thus a support structure of the adaptor 8. The support structure 22 may be formed from a single piece of injection molded plastic. The support structure 22 comprises a number of contact receiving portions as will now be described with reference to the following Figures.

FIG. 6 shows a perspective view of the support structure 22 of the control arrangement 12 focusing on the adaptor 8 thereof. The outermost annular wall 70 and the annular insulating member 68 can be seen more clearly in this Figure. The outermost annular wall 70 and the annular insulating member 68 are integrally formed with the support structure 22. As visible in this Figure, the adaptor 8 comprises a hole 74 configured to receive the pin 54 therein during assembly of the control arrangement 12. The hole 74 may thus be considered to be a pin receiving portion, as it is shaped and positioned to receive the pin 54. The support structure 22 may comprise a further structure, on the opposite side to that shown in FIG. 6, which receives the pin 54 and/or the module 28 of which it is part of.

In the embodiment shown in FIG. 6, the annular insulating member 68 acts to form both a first annular receiving portion and a second annular receiving portion. An inside surface 69 defines a first annular receiving portion, as it is this surface against which the third electrical contact 62 is mounted against. An outside surface 71 defines a second annular receiving portion as it is this surface against which the fourth electrical contact 64 is mounted against. An inside surface 73 of the outermost annular wall 70 also defines a third receiving portion, for receiving the fifth electrical contact 66.

FIG. 7 shows a view from underneath of the support structure 22. With reference to both FIGS. 6 and 7, the support structure 22 comprises a number of mounting holes for mounting the various electrical contacts thereto. Specifically, the support structure 22 comprises third electrical contact mounting holes 76A, 76B which receive protruding features on the third electrical contact 62. The support structure 22 further comprises fourth electrical contact mounting holes 78A, 78B, for receiving protruding features on the fourth electrical contact 64. The support structure 22 also comprises fifth electrical contact mounting holes 80A, 80B for receiving protruding features on the fifth electrical contact 66. The support structure 22 also comprises a third electrical contact connection hole 92, a fourth electrical contact connection hole 94, and a fifth electrical contact connection hole 96 through which a connection tab of each of the respective third, fourth and fifth electrical contacts 62, 64, 66 may extend for suitable connection to a component or electrical circuit within the control arrangement 12. Whilst a specific form of mounting features is set out above, it will be appreciated that the support structure 22 may comprise any suitable receiving portions that are capable of receiving the pin and various electrical contacts.

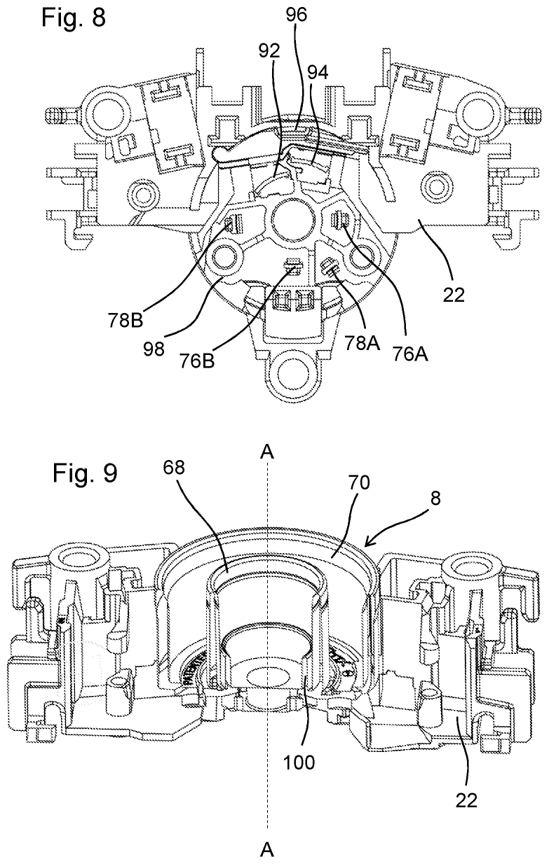

FIG. 8 shows a top-down view of the support structure 22 and illustrates how the third, fourth and fifth electrical contact mounting holes, 76A, 76B, 78A, 78B, 80A, 80B, together with the third, fourth and fifth electrical contact connection holes, 92, 94, 96 extend through the entire depth of the support structure 22 to a top surface 98 of the support structure 22.

FIG. 9 shows a cut-away view through the support structure 22 focusing on the adaptor 8 thereof. As can be seen in this Figure, in addition to the annular insulating member 68 and outermost annular wall 70, the adaptor 8 may further comprise an upstanding annular wall 100. The upstanding annular wall 100 may extend to a lesser extent along the axis of the adaptor 8, shown by dashed line A-A, than the annular insulating member 68. The upstanding annular wall 100 may function to assist with locating the third electrical contact 62 within the adaptor 8, and may further assist with supporting the third electrical contact 62 in place. The upstanding annular wall 100 may also serve to provide a suitable amount of electrical insulation between the base of the second electrical contact 58 and the base of the third electrical contact 62, which could each be at different potentials.

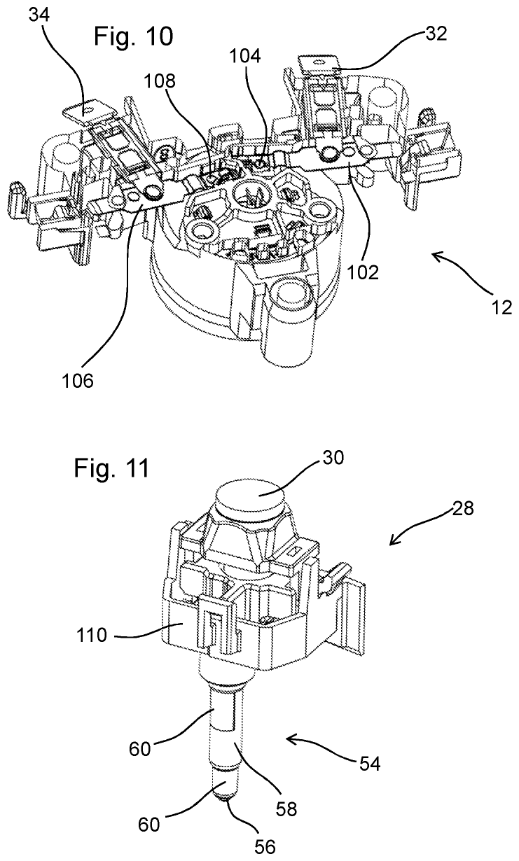

FIG. 10 shows a view of the control arrangement 12 with various components hidden to show more clearly the electrical connections within the control arrangement 12. As visible in this Figure, first electrical tab 32 is in electrical contact with a first intermediate connection member 102 which is connected to a first connection tab 104 which extends from the fourth electrical contact 64. The second electrical tab 34 is in electrical contact with a second intermediate connection member 106 which is connected to a second connection tab 108 which extends from the third electrical contact 62. As such, the first electrical tab 32 provides a means for connection to the fourth electrical contact 64 and the second electrical tab 34 provides a means for connection to the third electrical contact 62. The first and second electrical tabs 32, 34 may provide a live and neutral connection to an electrical component, e.g. a heating element 16, within the liquid heating vessel 4.

As discussed previously, in some embodiments, the pin 54 may be part of a module 28 which may be inserted into the support structure 22 so as to quickly and easily form the adaptor 8. FIG. 11 shows the module 28 which may be inserted into the control arrangement 12. The module 28 comprises the pin 54 which comprises the first and second electrical contacts 56, 58, which are separated by the insulating member 60. The module 28 comprises a mounting body 110 to which various parts of the module 28 are mounted. The module 28 further comprises an electrical component in the form of a temperature sensor 30. The temperature sensor 30 may comprise a negative temperature coefficient (NTC) thermistor. The following Figures show sectional and part views of the module 28 to illustrate its various parts.

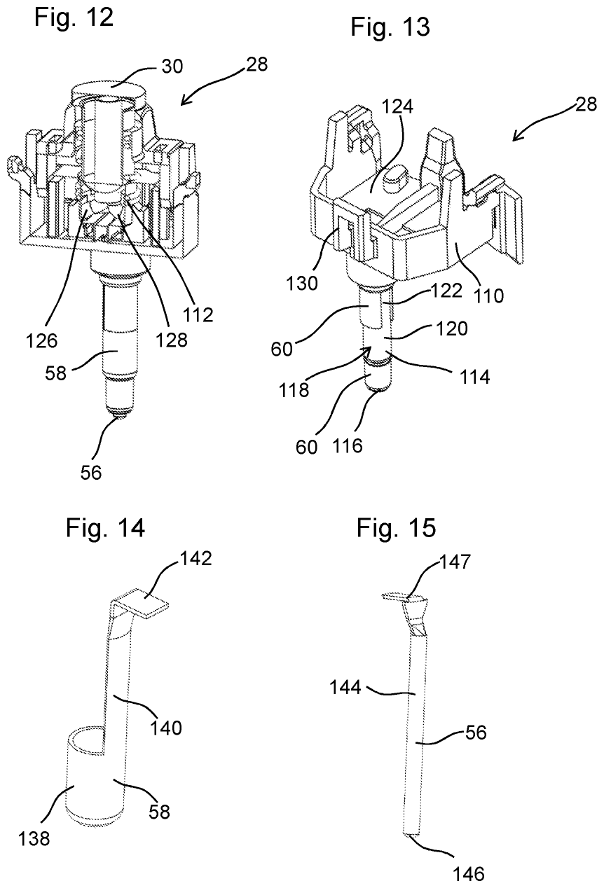

FIG. 12 shows a cut-away view through the module 28. As visible in this Figure, the module 28 may comprise a spring member 112, e.g. in the form of a coiled spring 112, which may be arranged to resiliently bias the temperature sensor 30 in an upwards direction. This resilient bias acting on the temperature sensor 30 may act to hold the temperature sensor 30 in close contact with a component whose temperature it is monitoring, when the control arrangement 12 is mounted to a liquid heating vessel 4. First and second electrical wires 126, 128 extend from the temperature sensor 30 and are connected to the first and second electrical contacts 56, 58, respectively.

FIG. 13 shows the mounting body 110, of the module 28, in isolation. As is visible in this Figure, the insulating member 60 is integrally formed with the mounting body 110. The mounting body 110 comprises a pin-shaped portion 114 which functions to provide the insulating member 60. The pin-shaped portion 114 comprises a hollow core (not visible in this Figure) through which the first electrical contact 56 extends. The pin-shaped portion 114 comprises an opening at an end thereof such that the first electrical contact 56 protrudes from a tip 116 of the pin-shaped portion 114, when inserted therein. The pin-shaped portion 114 further comprises a contact receiving portion 118 which comprises a circumferential portion 120 and an axially extending portion 122. The circumferential portion 120 and axially extending portion 122 receive respective parts of the second electrical contact 58. Whilst not visible in this Figure, a base 124 of the mounting body 110 comprises respective openings through which the first and second electrical contacts 56, 58 may extend so as to facilitate electrical connection within the module 28. The mounting body 110 further comprises a mounting feature 130 which may function to secure the module 28 in place on the control arrangement 12. The mounting feature 130 may engage with a suitably shaped projection on the support structure 22 which functions to hold the module 28 in position on the control arrangement 12.

FIG. 14 shows a perspective view of the second electrical contact 58 in isolation. As visible in this Figure, the second electrical contact 58 comprises a circumferentially extending portion 138, which is shaped to extend around the circumferential portion 120 on the mounting body 110. The second electrical contact 58 also comprises an axially extending portion 140 shaped to sit in the axially receiving portion 122 on the mounting body 110. The second electrical contact 58 further comprises a contact tab 142 which the second electrical wire 128, shown in FIG. 12, may be connected to.

FIG. 15 show a perspective view of the first electrical contact 56 in isolation. The first electrical contact 56 comprises an elongate portion 144 which is shaped and dimensioned to extend through the hollow core of the contact receiving portion 118 so that a tip 146 of the first electrical contact 56 protrudes from the contact receiving portion 118. The tip 146 allows an electrical connection with the first electrical contact 56 to be made.

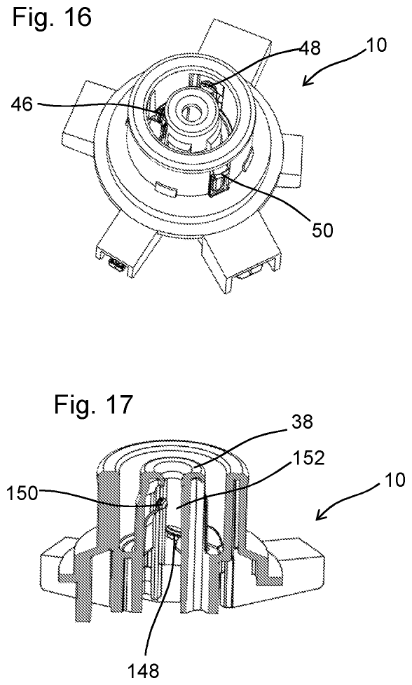

FIG. 16 shows a perspective view of the connector 10 of the control assembly 13. The corresponding third, fourth and fifth electrical contacts 46, 48, 50 can be seen in this Figure. FIG. 17 shows a cut-away view through the connector 10. As is visible in this Figure, within the hollow core 152 of the central boss 38, a corresponding first electrical contact 148 and a corresponding second electrical contact 150 are arranged. As shown, the corresponding first electrical contact 148 is oriented so as to touch the tip of the pin 54, and thereby touch the first electrical contact at the end thereof. In contrast, the corresponding second electrical contact 150 is oriented so as to contact the second electrical contact 58.

With reference to the above Figures, when the control arrangement 12, specifically the adaptor 8 thereof, is mated with the connector 10, an electrical connection will be formed therebetween. Specifically, the first electrical contact 56 will touch the corresponding first electrical contact 148, the second electrical contact 58 will touch the corresponding second electrical contact 150. These contacts 56, 58, 158, 150 may be for the provision of data transfer between the adaptor 8 and the connector 10. As such, when touching data may be transferred, from the temperature sensor 30, to the connector 10, e.g. to a controller arranged in the cordless power base 6.

When mated, the third electrical contact 62 will touch the corresponding third electrical contact 46 and the fourth electrical contact 64 will touch the corresponding fourth electrical contact 48. As such contacts provide a live and neutral connection, this may facilitate the transfer of electrical power between the adaptor 8 and the connector 10.

Similarly, when mated, the fifth electrical contact 66 will touch the corresponding fifth electrical contact 50. These contacts may provide an earth connection between the adaptor 8 and the connector 10.

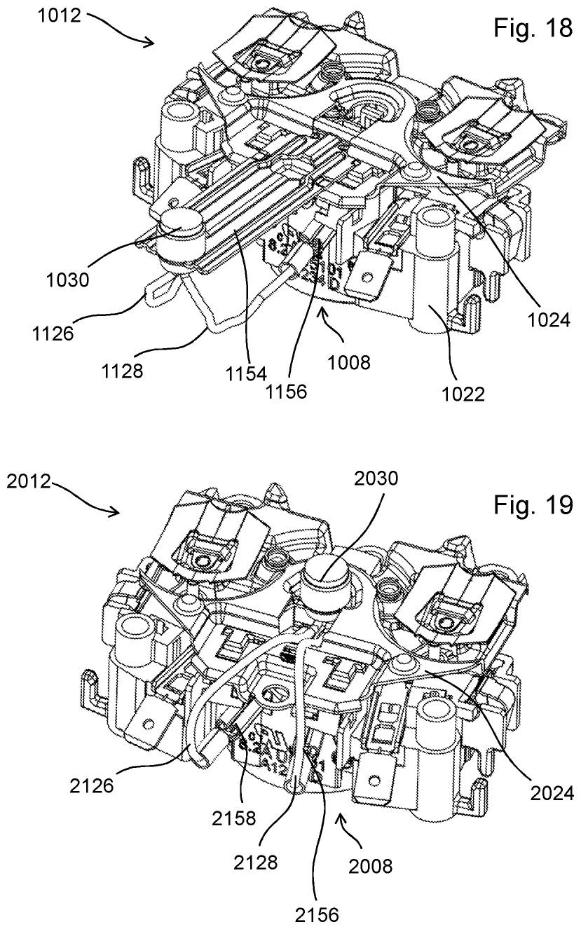

The embodiments set out above are not the only form of control arrangement which may be formed. FIG. 18 shows a perspective view of a control arrangement 1012 in accordance with another embodiment of the present invention. The control arrangement 1012 is substantially the same as the control arrangement 12 described above with the exception of some minor differences, which are set out below. Importantly, however, the control arrangement 1012 comprises an adaptor 1008 which substantially corresponds to the adaptor 8 set out above.

Unlike the embodiment described above wherein the temperature sensor 30 is provided as part of the module 28, in the embodiment shown in FIG. 18 the temperature sensor 1030 is mounted on a bracket 1154 which extends away from the support structure 1022 of the control arrangement 1012. The bracket 1154 may be mounted to the metal plate 1024. In this embodiment, the first and second electrical cables 1126, 1128 are longer than in the embodiment discussed above. The ends of the electrical cables 1126, 1128 comprise spade connectors 1156, 1158, one of which can be seen in FIG. 18 (the other can be seen in FIG. 21). Each of the spade connectors 1156, 1158 may be suitably connected to the first and second electrical contacts (not shown in FIG. 18) of the adaptor 1008.

FIG. 19 shows another embodiment of the control arrangement 2012. The control arrangement 2012 is substantially the same as the control arrangement 12 described above except for the following differences. Unlike in the first embodiment discussed above, the temperature sensor 2030 of this further embodiment is again not provided as part of a module. Instead, the temperature sensor 2030 is simply mounted to the metal plate 2024 on the top of the control arrangement 2012. The first and second electrical cables 2126, 2128 again extend from the temperature sensor 2030 and terminate with spade connectors 2156, 2158 which are suitably connected to the first and second electrical contacts (not visible in this Figure).

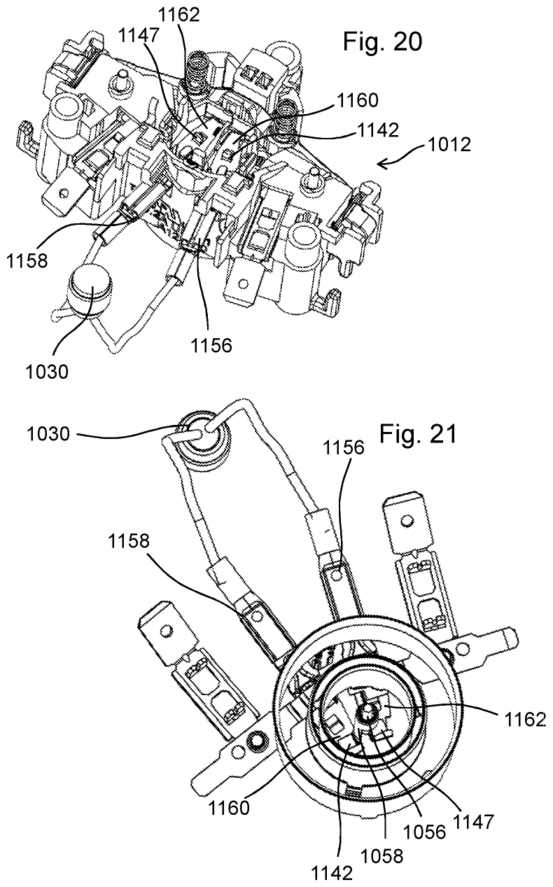

FIG. 20 shows a view of the control arrangement 1012 shown in FIG. 18, with the metal plate 1024 and bracket 1154 hidden so as to reveal the components underneath. As visible in this Figure, the first and second spade connectors 1156, 1158 are connected to first and second intermediate connectors 1160, 1162 which are connected to a contact tab 1142 of the second electrical contact (not visible in this Figure) and a contact tab 1147 of the first electrical contact (not visible in this Figure). The temperature sensor is thus connected to the first and second electrical contacts.

FIG. 21 shows a view from underneath the control arrangement 1012, showing only a limited number of electrical components to illustrate the electrical connection between the temperature sensor 1030. As visible in this Figure, the contact tab 1147 of the first electrical contact 1056 is in contact with the second intermediate connector 1162 and the contact tab 1142 of the second electrical contact 1058 is in contact with the first intermediate connector 1160. The spade connectors 1156, 1158 are connected to the first and second intermediate connectors 1160, 1162, thereby providing an electrical connection to the temperature sensor 1030. These Figures thereby demonstrate how the temperature sensor 1030 is connected to the first and second electrical contacts.

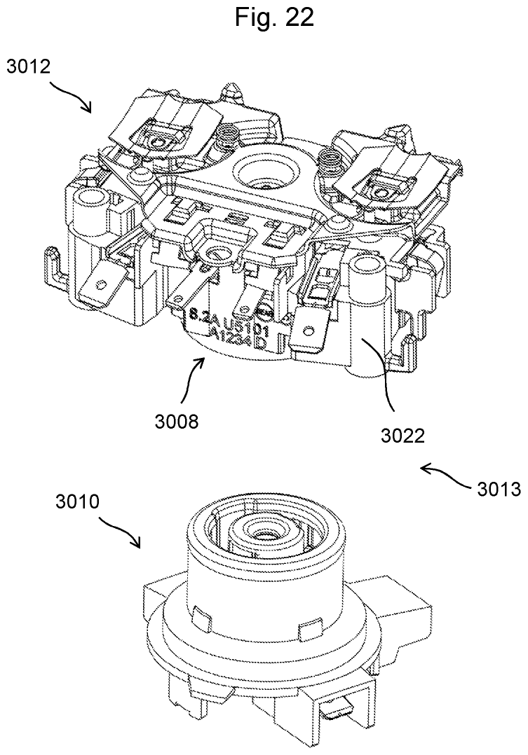

In the embodiments set out above, the control assembly is in the form of a 5-pole control assembly. However, in some embodiments of the present invention, the control assembly may comprise fewer contacts. Accordingly, FIG. 22 shows a perspective view of another control assembly 3013 in accordance with another embodiment of the present invention. Similar to previous embodiments, the control assembly 3013 comprises a control arrangement 3012 which comprises an adaptor 3008. The control assembly 3013 further comprises a cordless base connector 3010. However, unlike the embodiments discussed above wherein the adaptor and connector each comprised five electrical contacts, the adaptor 3008 and cordless base connector 3010 each comprise three electrical contacts, thus making this embodiment a 3-pole control assembly 3013. Whilst this embodiment is shown comprising a control arrangement 3012, it will be appreciated that the adaptor 3008 need not necessarily be part of such a control arrangement 3012 and may instead be provided in isolation.

Importantly, in the embodiment shown in FIG. 22, the support structure 3022 is identical the support structure 22 of the embodiment described above. As such, a single support structure is used for forming both a 5-pole and 3-pole control assembly. This may reduce the number of different parts that have to be manufactured in order to make different control assemblies.

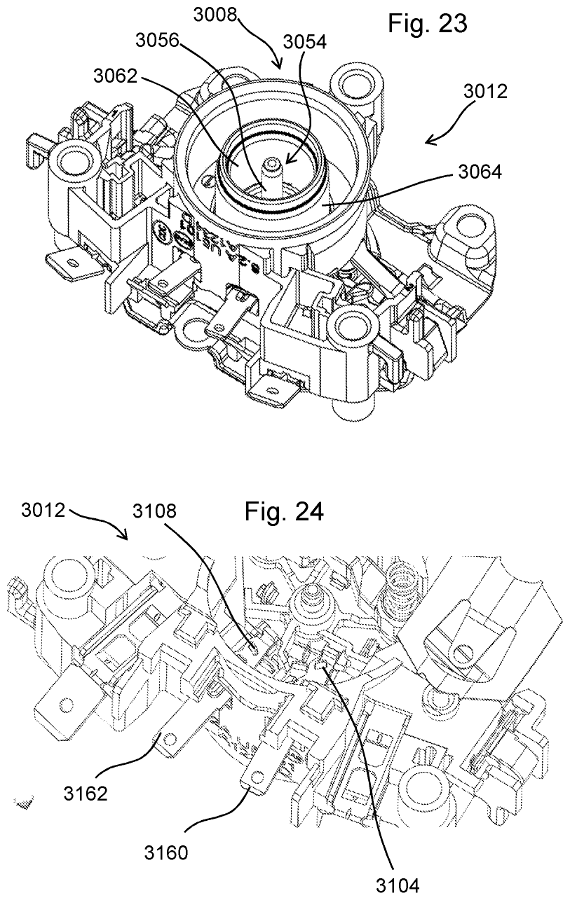

FIG. 23 shows a perspective view of the underside of the control arrangement 3012. In this embodiment, the adaptor 3008 comprises a different pin 3054 which only comprises a first electrical contact 3056, rather than both a first and second electrical contact. The adaptor 3008 further comprises a second electrical contact 3062 (which is identical to the third electrical contact 62 of the embodiment described above) and a third electrical contact 3064 (which is identical to the fourth electrical contact of the embodiment described above). In this embodiment, there is no fifth electrical contact inserted into the adaptor 3008.

FIG. 24 shows a view of the control arrangement 3012 with a number of the parts thereof hidden so as to more clearly show the electrical connection to the second and third electrical contacts 3062, 3064. As visible in this Figure, a first power connection tab 3160 may be connected to a first connection tab 3104 which extends from the second electrical contact 3062 and a second power connection tab 3162 may be connected to a second connection tab 3108 which extends from the third electrical contact 3064. The first and second power connection tabs 3160, 3162 may be connected to any component within the liquid heating vessel which requires electrical power.

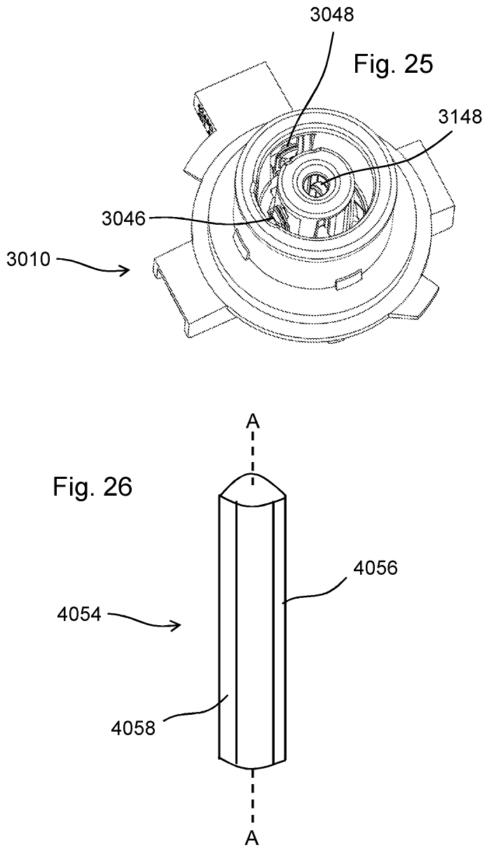

FIG. 25 shows a perspective view of the cordless base connector 3010. As visible in this Figure, the cordless base connector 3010 comprises a corresponding first electrical contact 3148, a corresponding second electrical contact 3046 and a corresponding third electrical contact 3048. Whilst not shown in this embodiment, the cordless base connector 3010 may comprise a connector support structure which is identical to the connector support structure of the 5-pole cordless base connector 10 set out above.

In any of the embodiments described above, whilst the adaptor is shown as part of a control arrangement, it will be appreciated that the control arrangement may be omitted and the adaptor may be provided in isolation or instead form part of a different component.

In the embodiment of the 5-pole adaptor 8 set out above, the first and second electrical contacts 56, 58 are axially displaced along the pin 54. However, this is not essential and instead the contacts may be circumferentially displaced. FIG. 26 shows a perspective view of a pin 4054 according to another embodiment of the present invention. As shown in this Figure, the pin 4054 comprises first and second electrical contacts 4056, 4058. However, unlike the previous embodiment whereby the electrical contacts were separated along the axis A-A, in this embodiment, the first and second electrical contacts are separated around the circumference of the pin 4054. Even with this arrangement it may be possible to achieve an electrical connection that can be made irrespective of the angular orientation of the adaptor and corresponding connector, by suitable placement of the corresponding contacts within the cordless base connector.

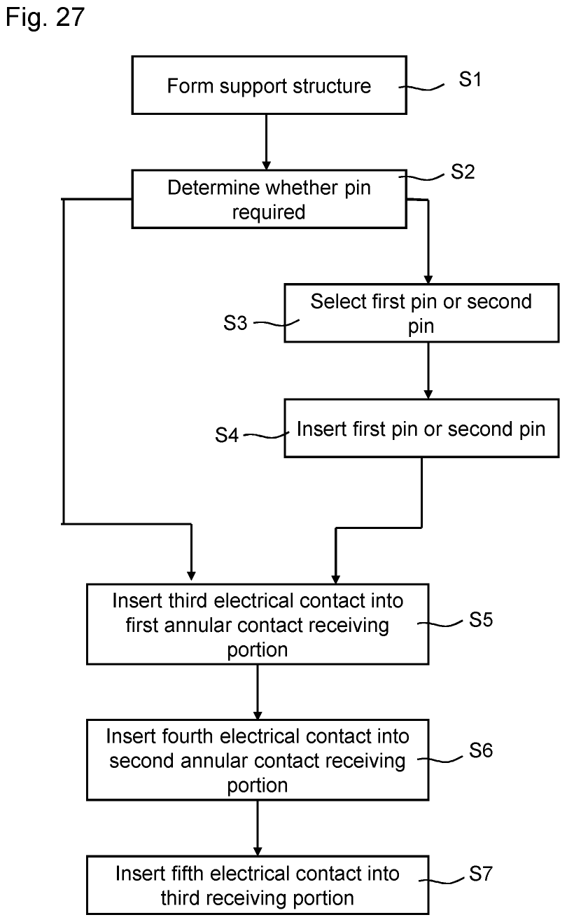

As set out above, the 3-pole and 5-pole control assemblies each comprise an adaptor which has a common support structure. FIG. 27 shows a flow chart of a method for forming an adaptor for a control assembly, in accordance with an embodiment of the present invention, which demonstrates how a common support structure can be used to form different adaptors.

The method comprises forming a support structure in step S1. The support structure formed in step S1 may have the form of the support structure 22 set out above. The support structure may be formed by injection molding. In step S2, a determination is made as to whether a pin is required. This determination may be based on an assessment as to how many electrical contacts are required within the adaptor.

If a pin is required, the method proceeds to step S3 whereby either a first pin, comprising a first electrical contact is selected, or a second pin comprising a first electrical contact and a second electrical contact is selected. The first pin may be selected when it is desired to produce a 3-pole adaptor, whereas the second pin may be selected when it is desired to produce a 5-pole adaptor. The method then proceeds to step S4 whereby the selected pin, i.e. the first or second pin, is inserted into the support structure. The method then proceeds to step S5 wherein a third electrical contact, having an annular form, is inserted into the first annular contact receiving portion. Following this, the method proceeds to step S6, wherein the fourth electrical contact is inserted into the second annular contact receiving portion. Where a 5-pole adaptor is required, and the second pin is selected and inserted in steps S3 and S4, the method may also involve step S7 whereby the fifth electrical contact is inserted into the third receiving portion.

When at step S2 it is determined that a pin is not required, for example because no earth connection is required, the method may instead proceed to steps S5 and S6, whereby the third and fourth electrical contacts are inserted, and step S3 and S4 may be omitted. This may form a 2-pole adaptor.

Whilst the method has been explained in an order above, it will be appreciated that the steps of the method may be performed in any appropriate order. For example, the steps S5, S6 and S7 of inserting the third, fourth and optionally the fifth electrical contact may be performed ahead of steps S2, S3 and S4 of determining whether a pin is required, selecting a pin and inserting the pin. It will also be appreciated that in some embodiments, where it is pre-set that the adaptor must comprise a pin, the step of determining whether a pin is required may be omitted, and the method may instead proceed directly to steps S3 and S4.

The method set out above may equally be applied to the formation of a cordless base connector. The method may comprise the formation of a connector support structure followed by the insertion of an appropriate number of a corresponding first, second, third, fourth and fifth electrical contacts into the connector support structure. The cordless base connector may thus comprise a corresponding number of contacts as the adaptor to which it is to be paired with.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A control assembly, for a cordless liquid heating apparatus comprising a liquid heating vessel and a cordless power base, the control assembly comprising:
a cordless base connector for mounting to the cordless power base; and
an adaptor for mounting to the liquid heating vessel, the adaptor configured to mate with the cordless base connector when the liquid heating vessel is seated on the cordless power base, wherein the adaptor comprises:
a pin comprising first and second electrical contacts arranged to connect with corresponding first and second electrical contacts in the cordless base connector;
a third electrical contact having an annular form extending around, and radially displaced from, the pin, and arranged to connect with a corresponding third electrical contact in the cordless base connector; and
a fourth electrical contact having an annular form extending around, and radially displaced from, the third electrical contact, and arranged to connect with a corresponding fourth electrical contact in the cordless base connector;
wherein the third and fourth electrical contacts in the adaptor together with the corresponding third and fourth electrical contacts in the cordless base connector are configured to provide a live and neutral connection to the liquid heating vessel.

2. The control assembly of claim 1, wherein the adaptor further comprises a fifth electrical contact radially displaced from the pin and arranged to connect with a corresponding fifth electrical contact in the cordless base connector, and wherein the fifth electrical contact is configured to provide an earth connection for the liquid heating vessel.

3. The control assembly of claim 2, wherein the fifth electrical contact is displaced radially outwards of the fourth electrical contact.

4. The control assembly of claim 2, wherein the fifth electrical contact has an annular form.

5. The control assembly of claim 1, wherein the first and second electrical contacts in the adaptor together with the corresponding first and second electrical contacts in the cordless power base provide a signal connection for transferring data between the adaptor and cordless base connector.

6. The control assembly of claim 1, wherein the adaptor forms part of a control arrangement for mounting to the liquid heating vessel.

7. The control assembly of claim 6, wherein the control arrangement comprises an electronic component to which the first and second electrical contacts of the pin are electrically connected.

8. The control assembly of claim 7, wherein the pin and electronic component are formed as a module which is inserted into the adaptor.

9. The control assembly of claim 7, wherein the electronic component comprises a temperature sensor.

10. The control assembly of claim 1, wherein the third and fourth electrical contacts are separated by an annular insulating member, wherein the third electrical contact is in contact with an inward facing surface of the annular insulating member and wherein the fourth electrical contact is in in contact with an outward facing surface of the annular insulating member.

11. The control assembly of claim 1, wherein the pin comprises an insulating member arranged between the first and second electrical contacts.

12. The control assembly of claim 1, wherein the first and second electrical contacts are separated from one another along an axis of the pin.

13. The control assembly of claim 1, wherein the first and second electrical contacts are separated from one another around an axis of the pin.

14. The control assembly of claim 1, wherein the pin has a substantially cylindrical shape.

15. The control assembly of claim 1, wherein the control assembly is a 360° cordless control assembly.

16. The control assembly of claim 1, wherein the pin is arranged centrally on the adaptor.

17. A cordless liquid heating apparatus comprising:
a cordless power base for connection to a mains power supply;
a liquid heating vessel configured to be seated on the cordless power base; and
a control assembly as claimed in claim 1, wherein the adaptor is mounted to the liquid heating vessel and wherein the cordless base connector is mounted to the cordless power base.

18. The liquid heating apparatus of claim 17, wherein the liquid heating vessel comprises a chamber for receiving a volume of a liquid to be heated, and a heating element for heating the liquid within the vessel, and wherein the third and fourth electrical contacts are electrically connected to the heating element.

19. A support structure, for forming at least part of an adaptor configured to provide an electrical connection with a corresponding cordless base connector, the support structure comprising:
a pin receiving portion capable of receiving a plurality of different types of pins, said pins comprising at least a first pin carrying a first electrical contact and a second pin carrying a first electrical contact and a second electrical contact;
a first annular contact receiving portion capable of receiving a third electrical contact having an annular form;
a second annular contact receiving portion capable of receiving a fourth electrical contact having an annular form; and
a third receiving portion capable of receiving a fifth electrical contact.

20-22. (canceled)

23. A method of forming at least an adaptor of a control assembly, the adaptor being configured for mounting to a liquid heating vessel, the method comprising the steps of:
forming a support structure according to any one of claim 19;
determining whether a pin is required and when a pin is required:
selecting one of: a first pin carrying a first electrical contact or a second pin carrying a first electrical contact and a second electrical contact; and
inserting the selected pin into the pin receiving portion;
inserting a third electrical contact having an annular form into the first annular contact receiving portion; and
inserting a fourth electrical contact having an annular form into the second annular contact receiving portion.

24-25. (canceled)
